(19) United States
(12) Patent Application Publication
(10) Pub. No.: US 2023/0297667 A1
(43) Pub. Date: Sep. 21, 2023

(54) METHOD FOR PROVIDING DEVICE SHARING SERVICE IN ISOLATION ENVIRONMENT AND SERVER PERFORMING THE SAME

(71) Applicant: ERmind Co., Ltd., Seoul (KR)

(72) Inventors: Chul Oh Park, Yangpyeong-gun (KR); Min Chul Kim, Seoul (KR); Hyung Sub Kim, Gunpo-si (KR)

(73) Assignee: ERmind Co., Ltd., Seoul (KR)

(21) Appl. No.: 18/119,823

(22) Filed: Mar. 10, 2023

(30) Foreign Application Priority Data
Mar. 16, 2022 (KR) 10-2022-0032743

(51) Int. Cl. G06F 21/53; H04L 9/40

(52) U.S. Cl. CPC G06F 21/53; H04L 63/101; H04L 63/1466; H04L 63/1416; G06F 2221/034

(57) ABSTRACT

The present disclosure relates to a method for providing a device sharing service in an isolated environment, the method comprising: providing a screen of a website being accessed through a remote browser to a user device; receiving an execution request for an event capable of being provided by the user device from an operating server of the website;

acquiring user data collected from the user device in response to the execution request for the event; converting the user data into remote user data for transmission to the operating server; and providing the remote user data to the operating server.

### CROSS-REFERENCE TO RELATED APPLICATIONS

This application claims the priority of Korean Patent Application No. 10-2022-0032743 filed on Mar. 16, 2022, in the Korean Intellectual Property Office, the disclosure of which is incorporated herein by reference.

### BACKGROUND

### Field

The present disclosure relates to a method for providing a device sharing service in an isolated environment and a server performing the same.

### Description of the Related Art

To protect a user device from external hacking, cloud computing systems are being used to a request of the user device. The cloud computing system is a virtualization technology-based system that executes the user device in a remote computer.

Specifically, a virtualization system includes virtual machines allocated to each of user devices and a virtual machine monitor or hypervisor that manages the virtual machine. Each virtual machine exists as an isolated space. Accordingly, even when a threat occurs in the virtual machine, the virtualization system does not affect other virtual machines except for the corresponding virtual machine and virtual machine monitors, so it is being used in security solutions.

In the virtualization system, since entire data processing is generally performed in a virtual space, there is no security threat to the user device. However, the virtualization system has limitations in providing some of web services that require resources obtainable from the user device to user device.

The description of the related art has been prepared to facilitate understanding of the disclosure. It should not be construed as acknowledging that matters described in the description of the related art exist as prior arts.

### SUMMARY

Accordingly, a conventional method of using resources of a user device in an isolated environment at a remote location has been disclosed. However, the method should be accompanied with a cumbersome process of installing a separate program for allocating the resources in each of the user device and a virtualization system.

Thus, there is a demand for a method for conveniently using resources of a user device required for each web service without the need to install a separate program in the user device.

As a result, the inventors of the present disclosure have intended to develop a method capable of using a necessary web service while protecting a user device from external threats, and a server performing the same. The method may include receiving a portion of user data from the user device and converting the data into sharable data, when receiving an event execution request for an event that can be provided by the user device while using a web service in a remote browser.

A method for providing a device sharing service in an isolated environment according to an exemplary embodiment of the present disclosure is provided. The method comprises providing a screen of a website being accessed through a remote browser to a user device; receiving an event execution request for an event capable of being provided by the user device from an operating server of the website; acquiring user data collected from the user device in response to the event execution request; converting the user data into remote user data for transmission to the operating server; and providing the remote user data to the operating server.

According to a feature of the present disclosure, the providing of the screen of the website may further include rendering a webpage screen capable of sharing the user data with other user devices.

According to another feature of the present disclosure, the event may include input/output data corresponding to the user data or an event requesting a list of devices connected to the user device and capable of acquiring the input/output data.

According to still another feature of the present disclosure, the method may further include, prior to receiving the event execution request, receiving an event requesting the list of the devices from the operating server, and acquiring a list of devices that are approved through the user device in response to the event.

According to still another feature of the present disclosure, the method further include, after acquiring the list of the approved devices, converting the list of the approved devices into a remote device list so as to transmit the list of the approved devices to the operating server through the remote browser; and transmitting the remote device list to the operating server.

According to still another feature of the present disclosure, the user data may include data of at least one of videos, images, audio and text output from the user device, and motion data detected by the user device.

According to still another feature of the present disclosure, the method may further include, after the providing to the operating server, rendering a webpage screen in which the remote user data is shared through the remote browser; and transmitting the rendered screen to the user device.

According to still another feature of the present disclosure, the method may further include, after the receiving of the event execution request for the event, providing a notification window for confirming whether the event is executed to the user device.

According to still another aspect of the present disclosure, the rendering the webpage screen may further include acquiring output data of a browser installed in the user device or output data of the user device; and applying the acquired output data to the webpage screen processed by the remote browser.

According to still another feature of the present disclosure, a security service providing server according to another exemplary embodiment of the present disclosure is provided. The security service providing server comprises a communication interface; a memory; and a processor operatively connected to the communication interface and the memory, and the processor is configured to provide a screen of a website being accessed through a remote browser to a user device, receive an event execution request for an event capable of being provided by the user device from an operating server of the website, acquire user data collected from the user device in response to the event execution request, convert the user data into remote user data for transmission to the operating server, and provide the remote user data to the operating server.

The details of other embodiments are included in the detailed description of invention and drawings.

According to the present disclosure, data collected from a user device can be safely shared with other user devices while a virtualized system replacing the user device is operated in an isolated environment at a remote location.

In addition, according to the present disclosure, it is unnecessary to install a separate program in a user device. Further, user data collected from the user device can be easily shared without providing specific connection information of an additional device connected to the user device.

Moreover, according to the present disclosure, a security service providing server for providing such a service requires only an isolated browser engine for executing URLs and streaming user data. Thus, development costs for providing the service can be greatly reduced.

Furthermore, according to the present disclosure, a remote browser provides a webpage screen reflecting output settings of a user device and a browser installed in the user device. Thus, it is possible to provide natural security services such as using web services through a default browser installed in the user device.

The effects according to the present disclosure are not limited by the contents exemplified above, and more various effects are included in the present disclosure.

### BRIEF DESCRIPTION OF THE DRAWINGS

FIG. 1 is a schematic diagram for explaining an outline of a general web service use method.

FIGS. 2 and 3 are block diagrams illustrating a configuration of a security service providing system according to an exemplary embodiment of the present disclosure.

FIG. 4 is a block diagram illustrating a configuration of a security service providing server according to an exemplary embodiment of the present disclosure.

FIG. 5 is a schematic flowchart of a method for providing a device sharing service in an isolation environment to an exemplary embodiment of the present disclosure.

FIG. 6 is a detailed flowchart of a method for providing a device sharing service for a video conference according to an exemplary embodiment of the present disclosure.

FIG. 7 is a detailed flowchart of a method for providing a device sharing service for a video conference according to another exemplary embodiment of the present disclosure.

### DETAILED DESCRIPTION OF THE EMBODIMENT

Advantages and features of the present disclosure and methods to achieve them will become apparent from descriptions of embodiments herein below with reference to the accompanying drawings. However, the present disclosure is not limited to the embodiments disclosed herein but may be implemented in various different forms. The embodiments are provided to make the description of the present disclosure thorough and to fully convey the scope of the present disclosure to those skilled in the art. It is to be noted that the scope of the present disclosure is defined only by the claims. In connection with the description of drawings, the same or like reference numerals may be used for the same or like elements.

In the disclosure, expressions “have,” “may have,” “include” and “comprise,” or “may include” and “may comprise” used herein indicate presence of corresponding features (for example, elements such as numeric values, functions, operations, or components) and do not exclude the presence of additional features.

In the disclosure, expressions “A or B,” “at least one of A or/and B,” or “one or more of A or/and B,” and the like used herein may include any and all combinations of the associated listed items. For example, the “A or B,” “at least one of A and B,” or “at least one of A or B” may refer to all of case (1) where at least one A is included, case (2) where at least one B is included, or case (3) where both of at least one A and at least one B are included.

The expressions, such as “first,” “second,” and the like used herein, may refer to various elements, but do not limit the order and/or priority of the elements. Furthermore, such expressions may be used to distinguish one element from another element but do not limit the elements. For example, a first user device and a second user device indicate different user devices regardless of the order or priority. For example, without departing from the scope of the present disclosure, a first element may be referred to as a second element, and similarly, a second element may also be referred to as a first element.

It will be understood that when an element (for example, a first element) is referred to as being “(operatively or communicatively) coupled with/to” or “connected to” another element (for example, a second element), it can be understood as being directly coupled with/to or connected to another element or coupled with/to or connected to another element via an intervening element (for example, a third element). On the other hand, when an element (for example, a first element) is referred to as being “directly coupled with/to” or “directly connected to” another element (for example, a second element), it should be understood that there is no intervening element (for example, a third element) therebetween.

According to the situation, the expression “configured to (or set to)” used herein may be interchangeably used with, for example, the expression “suitable for,” “having the capacity to,” “designed to,” “adapted to,” “made to,” or “capable of”. The term “configured to (or set to)” may not necessarily mean only “specifically designed to” in hardware. Instead, the expression “a device configured to” in any situation may mean that the device is “capable of operating together with another device or other components. For example, a “processor configured to (or set to) perform A, B, and C” may mean a dedicated processor (for example, an embedded processor) for performing a corresponding operation or a generic-purpose processor (for example, a central processing unit (CPU) or an application processor) which may perform corresponding operations by executing one or more software programs which are stored in a memory device.

Terms used in the present disclosure are used to describe specified embodiments of the present disclosure and are not intended to limit the scope of other embodiments. The terms of a singular form may include plural forms unless otherwise specified. All the terms used herein, which include technical or scientific terms, may have the same meaning that is generally understood by a person skilled in the art. It will be further understood that terms which are defined in a dictionary among terms used in the disclosure, can be interpreted as having the same or similar meanings as those in the relevant related art and should not be interpreted in an idealized or overly formal way, unless expressly defined in the present disclosure. In some cases, even in the case of terms which are defined in the specification, they cannot be interpreted to exclude embodiments of the present disclosure.

Features of various exemplary embodiments of the present disclosure may be partially or fully combined or coupled. As will be clearly appreciated by those skilled in the art, technically various interactions and operations are possible, and respective embodiments may be implemented independently of each other or may be implemented together in an associated relationship.

For clarity of interpretation of the present specification, terms used herein will be defined below.

A website described in the present disclosure may refer to an aggregate in which users store corresponding data in their operating server. All users can access the data in the website through wired/wireless communications. The data stored in the website can be displayed on a default browser (a local browser) of a user device 100 and a remote browser of a security service providing server 200 through webpages.

In addition, the webpages may refer to online documents on communication networks that are accessible through wired/wireless communications such as the Internet and the like. For example, one website may include a plurality of webpages. The website may provide the user with in the format of text, pictures, sound, images, or videos. In this case, the data included in the corresponding website may be directly displayed on the website or provided in a downloadable format through the website.

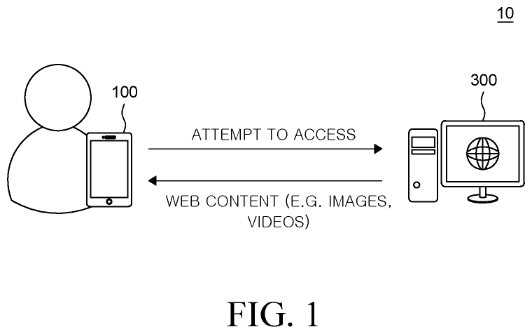

FIG. 1 is a schematic diagram for explaining an outline of a general web service use method.

Referring to FIG. 1, a general web service system 10 may include the user device 100 and an operating server 300 of a website. The user device 100 can access various websites through URLs and IP addresses. The operating server 300 of the website may provide a web content such as images, videos, text and the like included in the website to the user device 100.

In the web service system 10, the operating server 300 may directly request the user device 100 to receive device information and user data collected from the user device 100. However, when the user device 100 accesses an unsafe website, there is a risk that the user's personal information may be leaked.

To this end, the security service providing server 200 capable of verifying stability of the website and providing a safe web content may be located between the user device 100 and the operating server 300.

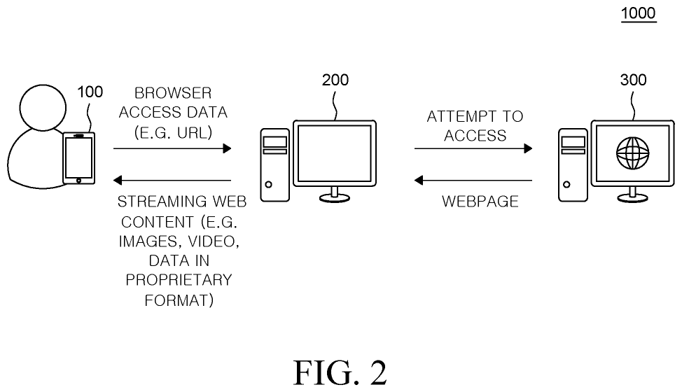

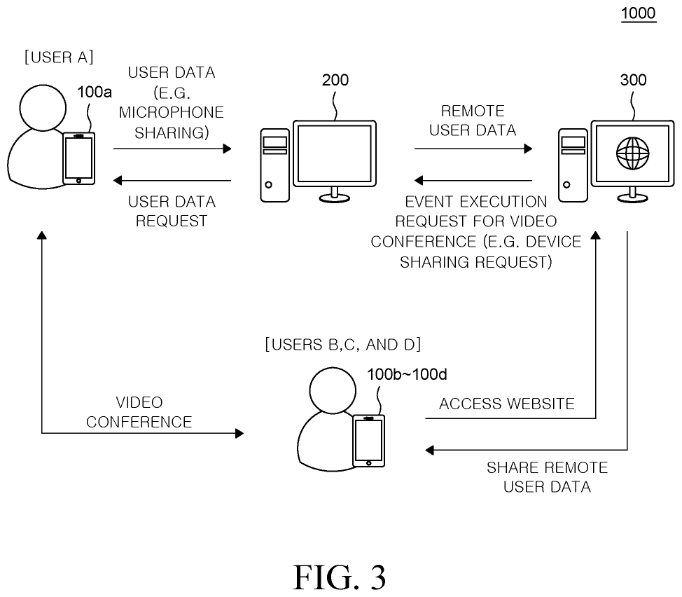

FIGS. 2 and 3 are block diagrams illustrating a configuration of a security service providing system according to an exemplary embodiment of the present disclosure.

First, referring to FIG. 2, a security service providing system 1000 may include the user device 100, the security service providing server 200, and the operating server 300 of the website.

The user device 100 may use various web services provided through mobile/web applications on a security system at a remote location. To use the web service, the user device 100 may include various types of devices that may be possessed or carried by the user. For example, the user device 100 may include a smart phone, PC, tablet PC, and the like.

The user device 100 may transmit browser access data input by the user to the security service providing server 200. For example, browser access data may include URLs, IP addresses, and the like.

The security service providing server 200 may access a website corresponding to browser access data instead of the default browser (a local browser) installed in the user device 100.

The security service providing server 200 may render an image or video of a website requested by the user device 100 in a format capable of being streamed in real-time (e.g., data in a proprietary format) and provide the rendered image or video to the user device 100.

In addition, the security service providing server 200 may reflect output data of the user device 100 or the local browser installed in the user device 100 in a process of providing a screen of the accessed website. Here, the output data may be visual, auditory, or tactile output data set in a browser application of the user device 100. For example, the output data may include a resolution and alarms of the browser application, a pattern and an intensity of vibration according to the alarm, and the like.

In this manner, the security service providing server 200 streams the screen of the website in real-time and provides it to the user device 100. Thus, the user can have an experience such as actually visiting the website on the user device 100. For example, like an operation of switching from a vertical screen to a horizontal screen, the security service providing server 200 may apply and stream an operation of changing displaying in the user device 100 and allow for displaying in the same method.

In addition, when the website requests user data, the security service providing server 200 does not directly transfer the website's request to the user device 100, but may receive user data from the user device 100 and convert it into data in a sharable form. For example, conversion of data may be understood as conversion of a file format of data.

The operating server 300 is a server that operates a website providing various web services. The operating server 300 may attempt to have access to the user device 100 according to a type of a service provided by the website. For example, the operating server 300 may operate all types of web services that share data of at least one of the user's face and voice, a screen output from the user device 100, and user interactions. The operating server 300 may attempt to share such data with the user device 100.

In various exemplary embodiments, the operating server 300 may provide a mobile/web application allowing for a device sharing service between user devices 100. Here, the device sharing service may be understood as a service for sharing data acquired from one device with another device. For example, the operating server 300 may identify a plurality of user devices 100 that are grouped for the device sharing service. The operating server 300 may transmit user data provided by any one of the user devices 100 to remaining user devices 100.

Referring to FIG. 3, the security service providing server 200 may access a mobile/website or execute a mobile/web application capable of sharing user data in place of a user device 100a of user A. Here, for convenience of descriptions of the present disclosure, it is assumed that a website requiring user data sharing is a site allowing for a video conference.

The operating server 300 of the website may identify user devices 100, 100a, 100b, 100c, and 100d of each of users A, B, C, and D sharing user data, and transmit an event execution request for a video conference (e.g., a request to share a separate device connected to the user devices 100) to each of the user devices 100.

Here, if the user device 100 is a user device not using a security service, the user device 100 may directly execute the corresponding event in the user device 100. And, the user device 100 may directly transmit a result of the execution to the operating server 300. For example, the user device 100 may provide audio data collected from a microphone connected thereto to the operating server 300 in real-time.

However, if the user device 100 is a user device using a security service, the user device 100 may receive an event execution request from the security service providing server 200. The security service providing server 200 may execute the corresponding event in place of the user device 100.

That is, the security service providing server 200 may receive an event execution request for a video conference (e.g., a request to share a separate device connected to the user devices 100) from the operating server 300 of the website. The security service providing server 200 may request user data from the user device 100a providing the security service. The security service providing server 200 may receive, for example, a microphone sharing (audio data stream) from the user device 100a. The security service providing server 200 may convert it into a format capable of being transmitted to the operating server 300.

In the present disclosure, user data in a format capable of being transmitted to the operating server 300 is defined as remote user data. The security service providing server 200 may transmit the remote user data to the operating server 300 that operates a video conference web service. In this case, the remote user data may be identical to the user data in a content thereof but may be different from the user data in a format of data. The remote user data may be output in the same form as unconverted user data of other user devices 100 on the video conference website. That is, three pieces of data, 1) user data transmitted by the user device 100 according to the prior art, that is directly connected to the operating server 300, 2) user data that the user device 100 requests the security service providing server 200 to share, and 3) remote user data that is shared by the security service providing server 200 with the operating server 300, include the same content, but may be configured in different data formats.

Accordingly, 3) remote user data may be output in the same format as the user data that is not converted in the website of the user device 100 or the operating server 300.

Accordingly, the operating server 300 may share remote user data with other user devices 100b, 100c, and 100d that access the mobile/website. The user devices 100b, 100c, and 100d sharing the remote user data may perform a video conference with the user device 100a using the security service.

So far, the security service providing system 1000 according to an exemplary embodiment of the present disclosure has been described. According to the present disclosure, device data collected from the user device 100 can be safely shared with other user devices while a virtualized system is operated in place of the user device in an isolated environment at a remote location. This can be performed without requesting the user device 100 to install a separate program.

Hereinafter, a configuration of the security service providing server 200 providing the device sharing service will be described.

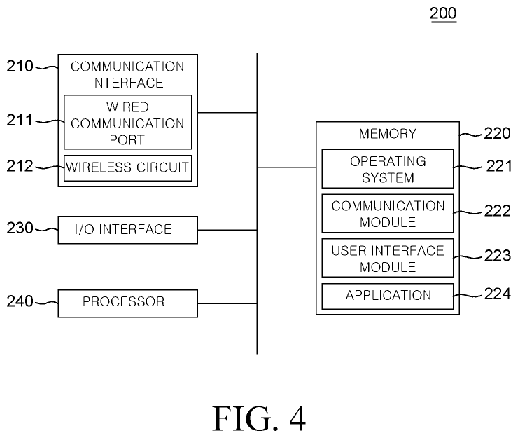

FIG. 4 is a block diagram illustrating a configuration of a security service providing server according to an exemplary embodiment of the present disclosure.

Referring to FIG. 4, the security service providing server 200 may include a communication interface 210, a memory 220, an I/O interface 230, and a processor 240, and the respective components may communicate with each other through one or more communication buses or signal lines.

The communication interface 210 may be connected to the user device 100 and the operating server 300 through wired/wireless communications network to receive and transmit data. For example, the communication interface 210 may receive browser access data, output data, a list of sharable devices, user data, and the like from the user device 100. The communication interface 210 may transmit a screen of a website that is accessed through a remote browser, to the user device 100. Here, the screen of the website may be a screen on which output data received from the user device 100 is reflected. For another example, the communication interface 210 may receive an event execution request for an event that can be provided by the user device 100 from the operating server 300 The communication interface 210 may transmit remote user data that can be shared with other user devices 100 to the operating server 300.

Meanwhile, the communication interface 210 allowing for transmission and reception of the data includes a wired communication port 211 and a wireless circuit 212. The wired communication port 211 may include one or more wired interfaces, for example, Ethernet, a universal serial bus (USB), a FireWire, and the like. Also, the wireless circuit 212 may transmit and receive data to and from an external device through an RF signal or an optical signal. In addition, wireless communications may use at least one of a plurality of communication standards, protocols and technologies, such as GSM, EDGE, CDMA, TDMA, Bluetooth, Wi-Fi, VoIP, Wi-MAX, or any other suitable communication protocols.

The memory 220 may store various pieces of data used in the security service providing server 200 therein. For example, the memory 220 may store identification information of the user devices 100 providing security services and store output data of each of the user devices 100. In addition, the memory 220 may store website information for each operating server 300, a list of accessible safe websites among URLs and IP addresses, a list of websites requiring blocking, and the like.

The memory 220 may store the context menu (browser setting data) by each type of web browser, a plurality of events included in the menu, and the hash values of the events encrypted by the hash function, and the like.

In various exemplary embodiments, the memory 220 may include a volatile or non-volatile recording medium capable of storing various pieces of data and information and various commands. For example, the memory 220 may include at least one type of storage medium among a flash memory type, a hard disk type, a multimedia card micro-type, a card type memory (e.g., an SD or XD memory), RAM, SRAM, ROM, EEPROM, PROM, a network storage, a cloud, and a blockchain database.

In various exemplary embodiments, the memory 220 may store a configuration of at least one of an operating system 221, a communication module 222, a user interface module 223, and one or more applications 224.

The operating system 221 (e.g., embedded operating systems such as LINUX, UNIX, MAC OS, WINDOWS, VxWorks, and the like) may include various software components and drivers for controlling and managing general system operations (e.g., memory management, storage device control, power management, and the like) and may support communications between various hardware, firmware, and software components.

The communication module 223 may support communications with other devices through the communication interface 210. The communication module 220 may include various software components for processing data received by the wired communication port 211 or the wireless circuit 212 of the communication interface 210.

The user interface module 223 may receive a user's request or input from a keyboard, a touch screen, a microphone, or the like through the I/O interface 230 and provide a user interface on a display.

The application 224 may include programs or modules that are configured to be executed by one or more processors 240. Here, the application for providing a security service and sharing user device-related data may be operated on a server farm.

The I/O interface 230 may connect an input/output device (not illustrated) of the security service providing server 200, for example, at least one of a display, a keyboard, a touch screen, and a microphone, with the user interface module 223. The I/O interface 230 may receive a user input (e.g., a voice input, a keyboard input, a touch input, or the like) together with the user interface module 223 and process a command according to the received input.

The processor 240 may be connected to the communication interface 210, the memory 220, and the I/O interface 230 to control an overall operation of the security service providing server 200. The processor 240 may perform various commands to share resources (user data collected from the user device 100) of the user device 100 through applications or programs stored in the memory 220.

The processor 240 may correspond to a computing device such as a central processing unit (CPU) or an application processor (AP). In addition, the processor 240 may be implemented in a form of an integrated chip (IC) such as a system on chip (SoC) in which various computing devices are integrated. Alternatively, the processor 240 may include a module for calculating an artificial neural network model, such as a neural processing unit (NPU).

Hereinafter, a method for providing a security service that enables the processor 240 to share resources of the user device 100 currently providing the security service with the other user devices 100 and the external operating server 300 in an isolated environment.

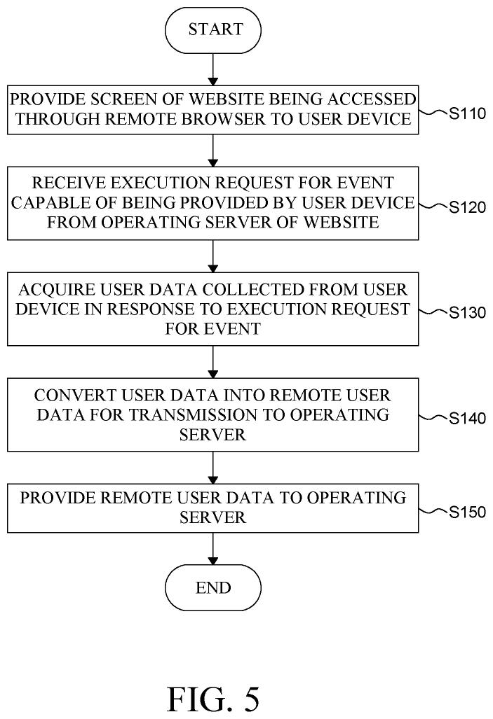

FIG. 5 is a schematic flowchart of a method for providing a device sharing service in an isolation environment performed to an exemplary embodiment of the present disclosure.

Referring to FIG. 5, the processor 240 may provide the user device 100 with a screen of a website being accessed through the remote browser (S110). For example, the website may be a website providing all types of web services that share data of at least one of a user's face and voice, a screen output from the user device 100, and user interactions.

The processor 240 may render a webpage screen capable of sharing user data with other user devices. That is, the processor 240 can change the screen of the webpage into a streamable format so that the screen of the webpage can be shared with the user device 100 in real-time.

In various exemplary embodiments, the processor 240 may provide the user device 100 with a screen having substantially the same form as a default browser installed in the user device 100 so that the user cannot recognize that the user is currently using a security service.

To this end, the processor 240 may acquire output data of the local browser (the browser installed in the device) from the user device 100 or output data of the user device 100 before rendering the screen of the webpage. Here, the output data may include various types of output data that can be confirmed visually and audibly, such as a resolution, font settings, page zoom settings, language settings, tab settings, screen rotation settings, and the like of the user device 100 or the default browser.

The processor 240 may apply the acquired output data to the webpage screen that is processed by the remote browser. For example, the processor 240 may change a font and a resolution of the webpage screen.

That is, the processor 240 may provide a webpage screen in which a website requested to be accessed by a user is executed as if it is executed in the local browser of the user device 100.

The processor 240 may receive an execution request for an event that can be provided by the user device 100 from the operating server 300 of the website (S120). Here, the execution request for the event may be understood as a request for an access to the device or a sharing event by the operating server 300 to the remote browser regarded as the user device 100. Specifically, the event may include 1) input/output data corresponding to user data or 2) an event requesting a list of devices connected to the user device 100 and capable of acquiring the input/output data. For example, the processor 240 may receive an event execution request for the following events. (e.g. an event requesting a list of devices connected to the user device 100, such as a microphone and a camera, an event requesting screen sharing output from the user device 100, an event requesting a user voice in the form of an audio stream, and the like.)

In various exemplary embodiments, the processor 240 may preferentially receive an event requesting a list of devices among events requested by the operating server 300. That is, the operating server 300 may confirm whether the corresponding user device 100 is a device capable of sharing other devices connected to the corresponding device. In response to this, the processor 240 may request a list of devices allowing for device sharing from the user device 100. The processor 240 may acquire a list of devices that are approved through the user device 100.

Thereafter, the processor 240 may convert the list of devices (hereinafter, also referred to as “device list”) into a remote device list to transmit the device list to the operating server 300 through the remote browser. Here, the remote device list may be identical to the device list acquired through the user device 100 in the content but may be different therefrom in data format. The processor 240 may transmit the remote device list to the operating server 300 through the communication interface 210. The operating server 300 may confirm the device list that can be shared by the user device 100 using the security service.

In various exemplary embodiments, the processor 240 may receive and process an event execution request for an event, and provide a notification window for confirming whether the event is executed to the user device 100. For example, the notification window may include the content asking a user's intention, such as “Do you allow for an access to a microphone?”. If the execution of the corresponding event is rejected through the notification window, the processor 240 may notify the operating server 300 that the execution of the corresponding event is infeasible. However, even if the execution of the event is infeasible, the processor 240 may render the screen of the website being accessed in real-time and provide it to the user device 100.

The processor 240 may acquire user data collected from the user device 100 in response to the execution request for the event(S130). An event at this time may be an event requesting input/output data corresponding to user data. Accordingly, the processor 240 may acquire user data including data of at least one of videos, images, audio, and text output from the user device, and motion data detected by the user device. For example, the processor 240 may acquire a webpage screen including a user's image captured by a camera of the user device 100. Here, the webpage screen may include a user's image in one area of the webpage screen provided through the remote browser.

That is, the processor 240 may acquire all kinds of interactions performed through the user device 100 in a format of user data while the web service is provided through the website.

In this manner, the processor 240 may execute a series of sequences (events) executed in the website to acquire user-related data, in place of the local browser of the user device 100. However, user data acquired from the user device 100 may be converted into remote user data in order to distinguish that the remote browser has executed a series of sequences (events) in place of the local browser.

The processor 240 may convert the user data into remote user data for transmission to the operating server 300 (S140). For example, the processor 240 may convert a file format of the user data. In other words, the remote user data may be identical to the user data in the content thereof but may be different from the user data in the format of data.

Accordingly, the remote user data may be output in the same format as the user data that is not converted in the website of the user device 100 or the operating server 300.

The processor 240 may provide the remote user data to the operating server 300 (S150). The processor 240 may provide the remote user data corresponding to user data requested by the corresponding webpage to the operating server 300. The processor 240 may render a webpage screen in which the remote user data is shared through the remote browser.

In various exemplary embodiments, the processor 240 acquires output data of the browser installed in the user device 100 or output data of the user device 100. The processor 240 may apply the acquired output data to the webpage screen processed by the remote browser. For example, the output data may include a resolution and alarms of the browser application, a pattern and an intensity of vibration according to the alarm, and the like.

The processor 240 may provide the rendered screen to the user device 100 through the communication interface 210. Accordingly, the user may safely share user data provided by the user while protecting the user device 100 from the outside.

So far, the security service providing server 200 according to an exemplary embodiment of the present disclosure has been described. According to the present disclosure, the user device 100 can easily share user data through a remote browser. The remote browser provides a webpage screen reflecting output settings of the user device and the browser installed on the user device. Thus, it is possible to receive natural security services such as using web services through the default browser installed in the user device.

Hereinafter, an overall method for providing a device sharing service through the security service providing system 1000 will be described.

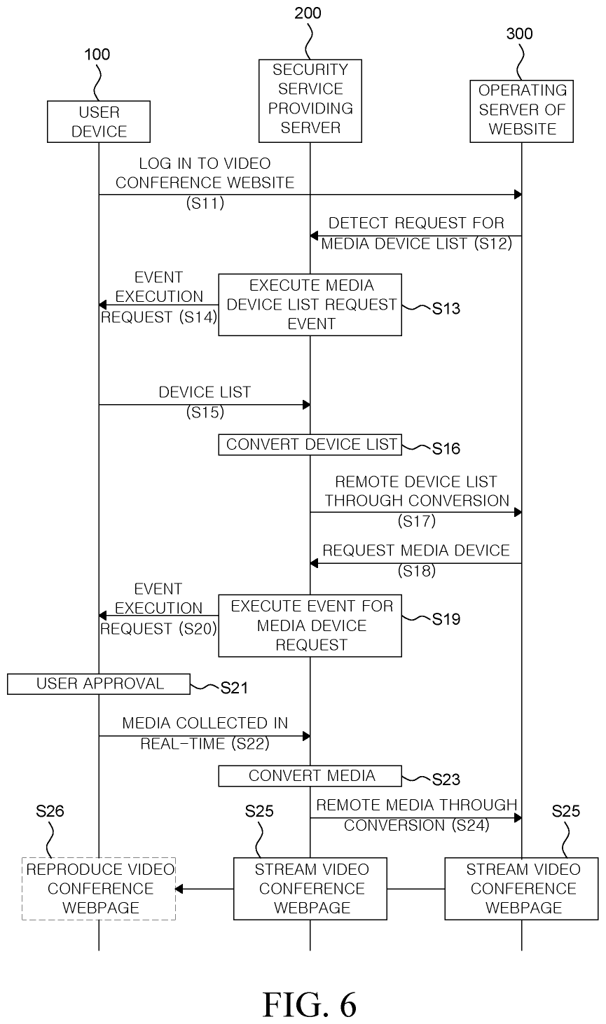

FIG. 6 is a detailed flowchart of a method for providing a device sharing service for a video conference according to an exemplary embodiment of the present disclosure.

Referring to FIG. 6, the user device 100 may remotely log in to a video conference website through the security service providing server 200 (S11). The security service providing server 200 may detect a request for a media device list from the operating server 300 while rendering and streaming a webpage screen included in the website (S12). In response to this, the security service providing server 200 may execute a media device list request event (S13) and may transmit an event execution request to the user device 100 (S14). For example, the security service providing server 200 may provide an event execution request notification window to the user device 100.

In various exemplary embodiments, the user device 100 may approve use authority of at least some media devices, and may provide a list of the approved media devices to the security service providing server 200.

The remote browser of the security service providing server 200 may acquire the media device list in place of the local browser (S15). The remote browser of the security service providing server 200 may convert the previously acquired media device list into a remote device list in order to distinguish that the security service providing server 200 transfers the remote device list in place of the user device 100 in S16. In this case, the remote device list may be identical to the media device list in the content thereof but may be different from the media device list in the format of data.

The operating server 300 can confirm the list of media devices that can be shared by the user device 100 using a security service (S17). In addition, at a time when the plurality of user devices 100 are grouped together as one group and allow for sharing of user data, the operating server 300 may request the media device of the user device 100 through the webpage (S18).

The security service providing server 200 providing the security service to the user device 100 may execute an event for a media device request (S19). The security service providing server 200 may transmit an execution request for an event to the user device 100 (S20). For example, the security service providing server 200 may provide an event execution request notification window to the user device 100.

In various exemplary embodiments, the user device 100 may approve the media device request (S21). Accordingly, the security service providing server 200 may receive media in real-time from any one of media devices acquired in the previous step S15 (S22). The security service providing server 200 may provide the collected media to the security service providing server 200.

The security service providing server 200 may convert media acquired through the user device 100 in real-time into remote media in order to distinguish that the remote browser acquires and transfers the media in place of the local browser (S23). In this case, the remote device list may be identical to the media device list in the content thereof but may be different from the media device list in the format of data.

The operating server 300 may confirm the media shared by the user device 100 using the security service (S24). The operating server 300 may stream the webpage in which the media is shared and provide it to the plurality of user devices 100 (S25). The security service providing server 200 may render the webpage streamed by the operating server 300 and provide it to the user device 100 (S25). The user device 100 may reproduce a video conference webpage through the local browser or basic application (S26).

Meanwhile, before the security service providing server 200 detects an execution request for an event from the operating server 300 in real-time, it may prepare for the execution request for the event in advance.

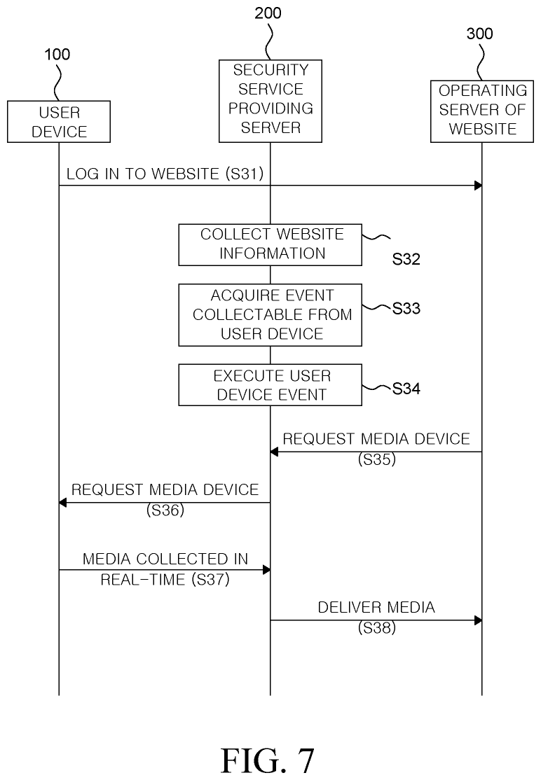

In relation to this, FIG. 7 is a detailed flowchart of a method for providing a device sharing service for a video conference according to another exemplary embodiment of the present disclosure.

Referring to FIG. 7, the user device 100 may remotely log in to a video conference website through the security service providing server 200 (S31). In this process, the security service providing server 200 may collect website information (S32), acquire events collectable from the user device 100 (S33), and then execute them (S34). Here, the executing of the event by the security service providing server 200 may be understood as predefining an event provided from the website so that a series of sequences requested to be executed by the user device 100 are executed in the security service providing server 200.

Accordingly, when the operating server 300 requests a media device (S35), the security service providing server 200 may request the media device to the user device 100 (S36). The security service providing server 200 may deliver media collected from the user device 100 in real-time to the operating server 300 (S37) and (S38).

So far, the method for providing a device sharing service according to various exemplary embodiments of the present disclosure has been described. According to the present disclosure, the security service providing server 200 can protect the user device 100 from external threats, while providing convenience so that necessary web services can be used.

Although the exemplary embodiments of the present disclosure have been described in detail with reference to the accompanying drawings, the present disclosure is not limited thereto and may be embodied in many different forms without departing from the technical concept of the present disclosure. Therefore, the exemplary embodiments of the present disclosure are provided for illustrative purposes only but not intended to limit the technical concept of the present disclosure. The scope of the technical concept of the present disclosure is not limited thereto. Therefore, it should be understood that the above-described exemplary embodiments are illustrative in all aspects and do not limit the present disclosure. The protective scope of the present disclosure should be construed based on the following claims, and all the technical concepts in the equivalent scope thereof should be construed as falling within the scope of the present disclosure.

What is claimed is:

1. A method for providing a device sharing service in an isolated environment, the method comprising:
providing a screen of a website being accessed through a remote browser to a user device;
receiving an execution request for an event capable of being provided by the user device from an operating server of the website;
acquiring user data collected from the user device in response to the execution request for the event;
converting the user data into remote user data for transmission to the operating server; and
providing the remote user data to the operating server.

2. The method of claim 1, wherein the providing of the screen of the website further includes rendering a webpage screen capable of sharing the user data with other user devices.

3. The method of claim 1, wherein the event includes input/output data corresponding to the user data or an event requesting a list of devices connected to the user device and capable of acquiring the input/output data.

4. The method of claim 3, further comprising:
prior to receiving the execution request,
receiving an event requesting the list of the devices from the operating server, and
acquiring a list of devices that are approved through the user device in response to the event.

5. The method of claim 4, further comprising:
after acquiring the list of the approved devices,
converting the list of the approved devices into a remote device list so as to transmit the list of the approved devices to the operating server through the remote browser; and
transmitting the remote device list to the operating server.

6. The method of claim 1, wherein the user data includes data of at least one of videos, images, audio and text output from the user device, and motion data detected by the user device.

7. The method of claim 2, further comprising:
after the providing to the operating server,
rendering a webpage screen in which the remote user data is shared through the remote browser; and
transmitting the rendered screen to the user device.

8. The method of claim 3, further comprising:
after the receiving of the execution request for the event,
providing a notification window for confirming whether the event is executed to the user device.

9. The method of claim 7, wherein the rendering the webpage screen further includes,
acquiring output data of a browser installed in the user device or output data of the user device; and
applying the acquired output data to the webpage screen processed by the remote browser.

10. A security service providing server comprising:
a communication interface;
a memory; and
a processor operatively connected to the communication interface and the memory;
wherein the processor is configured to,
provide a screen of a website being accessed through a remote browser to a user device, receive an execution request for an event capable of being provided by the user device from an operating server of the website, acquire user data collected from the user device in response to the execution request for the event, convert the user data into remote user data for transmission to the operating server, and provide the remote user data to the operating server.

11. The security service providing server of claim 10, wherein the processor is configured to render a webpage screen capable of sharing the user data with other user devices.

12. The security service providing server of claim 10, wherein the event includes input/output data corresponding to the user data or an event requesting a list of devices connected to the user device and capable of acquiring the input/output data and.

13. The security service providing server of claim 12, wherein the processor is configured to,
receive an event requesting the list of the devices from the operating server through the communication interface, and
acquire a list of devices that are approved through the user device in response to the event.

14. The security service providing server of claim 13, wherein the processor is configured to,
convert the list of the approved devices into a remote device list so as to transmit the list of the approved devices to the operating server through the remote browser; and
transmit the remote device list to the operating server through the communication interface.

15. The security service providing server of claim 10, wherein the user data includes data of at least one of videos, images, audio and text output from the user device, and motion data detected by the user device.

16. The security service providing server of claim 11, wherein the processor is configured to,
render a webpage screen in which the remote user data is shared through the remote browser; and
transmit the rendered screen to the user device through the communication interface.

17. The security service providing server of claim 12, wherein the processor is configured to,
provide a notification window for confirming whether the event is executed to the user device.

18. The security service providing server of claim 16, wherein the processor is configured to,
acquire output data of a browser installed in the user device or output data of the user device; and
apply the acquired output data to the webpage screen processed by the remote browser.
